(19) United States
(12) Patent Application Publication
(10) Pub. No.: US 2025/0297503 A1
(43) Pub. Date: Sep. 25, 2025

(54) Vehicle and Door Handle System Thereof

(71) Applicant: Illinois Tool Works Inc., Glenview, IL (US)

(72) Inventors: Feng Liu, Shanghai (CN); Po Hu, Shanghai (CN)

(21) Appl. No.: 19/082,669

(22) Filed: Mar. 18, 2025

(30) Foreign Application Priority Data
Mar. 19, 2024 (CN) 202410316924.6
Mar. 12, 2025 (CN) 202510297967.9

(51) Int. Cl. E05B 85/10; E05B 81/06

(52) U.S. Cl. CPC E05B 85/107; E05B 81/06; E05B 85/103

(57) ABSTRACT

The present disclosure provides a vehicle and a door handle system thereof, which includes a handle, a handle driving device and a projection device. The projection device is arranged in the handle and configured to, as the handle is deployed relative to the vehicle door, move from an obscured position to one or more projection position to project an image. A projection driving device drives the projection device to move. The deployment degree of the handle cooperates with the movement of the projection device to make the projection device project an image. The door handle system of the present disclosure can dynamically project images and project images of a wider variety of areas and shapes in a wider variety of projection regions to implement a wider variety of projection modes, thereby reducing the cost of improvement, without affecting the user experience and vehicle aesthetics and without being vulnerable to damage.

### RELATED APPLICATIONS

The present application claims the benefit of Chinese Patent Application Nos. 202410316924.6, filed Mar. 19, 2024, and 202510297967.9, filed Mar. 12, 2025, each titled “Vehicle and Door Handle System Thereof,” the contents of which are hereby incorporated by reference.

### TECHNICAL FIELD

The present disclosure relates to a vehicle, and in particular to a vehicle having a projection device.

### BACKGROUND

A vehicle uses a projection device to project an image on the ground near the vehicle. In the prior art, the patent document US20200377004 A1 discloses that a projection device is mounted under a conventional door handle of a vehicle to project an image on the ground near the vehicle. Moreover, the patent document CN 117043011 A discloses that a projection unit is mounted on a rear-view mirror of a vehicle, and can be pivoted or tilted between at least two positions according to a value of brightness in the surrounding environment that is detected by a brightness sensor, to project images of different areas on the ground near the vehicle.

### SUMMARY

The present disclosure relates generally to a vehicle and door handle system, substantially as illustrated by and described in connection with at least one of the figures, as set forth more completely in the claims.

### BRIEF DESCRIPTION OF THE DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1 shows a structural schematic view of a vehicle and its components and projection regions of the present disclosure.

FIG. 2A is a structural schematic perspective view of a handle shown in FIG. 1 mounted in a base of a vehicle door.

FIG. 2B is a front view of the handle shown in FIG. 2A in a partially deployed state.

FIG. 2C is a front view of the handle shown in FIG. 2A in a fully deployed state.

FIG. 3A is a structural schematic perspective view of a projection device and a projection driving device of the handle shown in FIG. 2A that are mounted together when viewed from a first angle.

FIG. 3B is a structural schematic perspective view of the projection device shown in FIG. 3A after being rotated by 30° around a first axis of rotation.

FIG. 3C is a structural schematic perspective view of the projection device shown in FIG. 3A after being rotated by 30° around a second axis of rotation.

FIG. 3D is a structural schematic perspective view of the projection device shown in FIG. 3A after being rotated by 30° around both the first axis of rotation and the second axis of rotation.

FIG. 3E is a structural schematic perspective view of the projection device and the projection driving device mounted together shown in FIG. 3A when viewed from a second angle.

FIGS. 4A-4C show schematic views of images in a first projection mode of the present disclosure.

FIG. 4D shows a schematic view of a projection region in which an image is projected in a second projection mode of the present disclosure.

FIG. 5A shows a schematic view of run-over regions of inner and outer wheels of the vehicle during a turn.

FIG. 5B is a schematic view of an image projected by the projection device at the beginning of the turn of the vehicle shown in FIG. 5A.

FIG. 5C is a schematic view of an image projected by the projection device half-way through the turn of the vehicle shown in FIG. 5A.

FIG. 5D is a schematic view of an image projected by the projection device near the completion of the turn of the vehicle shown in FIG. 5A.

FIG. 6 is a block diagram of the structure of a door handle system of the vehicle shown in FIG. 1.

FIG. 7 is a block diagram of the structure of a control device of the door handle system shown in FIG. 6.

### DETAILED DESCRIPTION OF EMBODIMENTS

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” “upper,” “lower,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples, and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y.” As another example, “x, y, and/or z” means any element of the seven-element set {(x), (y), (z), (x, y), (x, z), (y, z), (x, y, z)}. In other words, “x, y, and/or z” means “one or more of x, y, and z.”

It has been found, after extensive research, that in the patent publication US 20200377004 A1, the conventional door handle is fixedly mounted to a vehicle door so that the region, area and size of the image projected by a projection device mounted below the conventional door handle on the ground near the vehicle are relatively fixed, and dynamic projection display is impossible. Moreover, a user of the vehicle will touch or grip the projection device below the door handle when he/she grips the door handle to open the vehicle door, thereby reducing the user experience, and multiple touches or grips are likely to cause damage to or insecure mounting of the projection device. The mounting of the projection device under the conventional door handle also reduces the aesthetics of the vehicle. Furthermore, the projection device is exposed to the outside of the vehicle due to its mounting under the conventional door handle, and is thus likely to be damaged by dust, rain, light, etc.

It has also been found, after extensive research, that in the patent publication CN 117043011 A, the projection unit is mounted on the rear-view mirror of the vehicle so that the projection unit is located in a front portion of the vehicle at a higher height, the image projected by the projection unit on the ground can therefore be only within part of the length range of the vehicle, and the clarity of the image projected on the ground near the vehicle is reduced. The mounting of the projection unit on the rear-view mirror reduces the aesthetics of the vehicle. The projection unit is exposed to the outside of the vehicle due to its mounting on the rear-view mirror and is also likely to be damaged by dust, rain, light, etc. Moreover, the projection unit projects different images on the ground near the vehicle according to the value of brightness in the surrounding environment, but does not achieve a wider variety of interactions of the vehicle with other vehicles, pedestrians, etc. nor a wider variety of experiences for the user of the vehicle. Furthermore, the projection unit is only pivoted or tilted so that it is not possible to project images of a wider variety of shapes to accommodate multiple projection modes.

In order to solve the above technical problems, in a first aspect, the present disclosure provides a door handle system, including a handle, a handle driving device and a projection device. The handle driving device is configured to drive the handle to deploy or retract relative to the vehicle door. The projection device is arranged in the handle and has an obscured position and one or more projection position. The projection device is configured to, as the handle is deployed relative to the vehicle door, move from the obscured position to the one or more projection position so that the projection device projects an image to a projection surface.

According to certain specific embodiments, the door handle system further includes a projection driving device. The projection driving device is connected to the projection device and configured to drive the projection device to move relative to the handle.

According to certain specific embodiments, the projection device moves relative to the handle to project an image of a predetermined shape and area on a predetermined projection region of the projection surface.

According to certain specific embodiments, the projection driving device drives the projection device to rotate relative to the handle. The projection device rotates around a first axis of rotation and a second axis of rotation independently of each other.

According to certain specific embodiments, the handle is deployed or retracted along a plane relative to the vehicle door. The first axis of rotation and the second axis of rotation are parallel to the plane. The first axis of rotation is perpendicular to the second axis of rotation.

According to certain specific embodiments, the projection device and the projection driving device are arranged spaced apart from a grip portion of the handle in a longitudinal direction of the handle.

According to certain specific embodiments, the projection driving device comprises a first projection motor and a second projection motor. The first projection motor is configured to drive the projection device to rotate around the first axis of rotation. The second projection motor is configured to drive the projection device to rotate around the second axis of rotation.

According to certain specific embodiments, the projection driving device is mounted to the handle via a bracket. The bracket comprises a main body comprising a side surface which is mounted to the handle. The main body further comprises a first arm and a second arm arranged opposite to the side surface. The first projection motor is mounted to the first arm. The second projection motor is mounted to the second arm.

According to certain specific embodiments, a first output shaft of the first projection motor is connected to the projection device via a first connection member and a second connection member. The first output shaft rotates to drive the first connection member and the second connection member to rotate so as to drive the projection device to rotate around the first axis of rotation. A second output shaft of the second projection motor is connected to the projection device via a third connection member. The second output shaft rotates to drive the third connection member to rotate so as to drive the projection device to rotate around the second axis of rotation.

According to certain specific embodiments, the door handle system further includes a control device. The control device is configured to: control the operation of the handle driving device to deploy or retract the handle, control the operation of the projection driving device to move the projection device, and control the operation of the projection device to project the image.

According to certain specific embodiments, the control of a degree of deployment of the handle relative to the vehicle door, a manner of operation of the projection driving device and the movement of the projection device relative to the handle is determined based on an operating state of a vehicle.

According to certain specific embodiments, the projection device comprises a first projection head. In the first projection mode, during controlling the handle driving device to drive the handle to deploy, the control device controls the first projection head of the corresponding projection device mounted to the handle to actuate to project an image with a pattern, so that the projected image is gradually presented as the handle is gradually deployed.

According to certain specific embodiments, the projection device comprises a second projection head. In the second projection mode, the control device controls the handle driving device to drive the handle to deploy and controls the second projection head of the corresponding projection device mounted to the handle to actuate and project an image of a predetermined color for a predetermined duration.

According to certain specific embodiments, the projection device comprises a third projection head. In the third projection mode, as for each handle on two vehicle doors on one side of a vehicle and the corresponding first projection motor, second projection motor and projection device mounted to each handle, the control device controls the handle driving device to drive each handle to deploy to a predetermined degree of deployment, controls the operation of the corresponding first projection motor to drive the corresponding projection device to rotate around the first axis of rotation by a first angle of rotation, controls the operation of the corresponding second projection motor to drive the corresponding projection device to rotate around the second axis of rotation by a second angle of rotation, and controls the third projection head of the corresponding projection device to actuate and project an image of a predetermined color. The images projected by the corresponding third projection head on each handle are spliced to form a combined image.

According to certain specific embodiments, the third projection mode is a turning mode. The control of the degree of deployment of the handle relative to the vehicle door, the first angle of rotation of the projection device around the first axis of rotation and the second angle of rotation around the second axis of rotation are determined based on a turn angle signal and a vehicle speed signal of the vehicle.

According to certain specific embodiments, the control device is a single controller.

In a second aspect, the present disclosure provides a vehicle including the door handle system of any item of the above first aspect.

In the first aspect, the projection device is mounted to the handle such that as the degree of deployment of the handle relative to the vehicle door changes, the size of the part of the projection device that is obscured by the vehicle door changes accordingly to dynamically project a corresponding indication image on the projection surface (e.g., on the ground near the vehicle), thus being applicable to a wider variety of projection modes.

In the second aspect, the projection device is mount to the handle such that the projection device can be retracted into the vehicle door accordingly as the handle is retracted into the vehicle door, without affecting the aesthetics of the vehicle. Moreover, the projection device is exposed outside the vehicle only when in use and is hidden inside the vehicle door most of the time, so that the projection device is less likely to be mounted loosely or damaged due to the influence of the external environment (e.g., dust, rain, light, etc.) or external forces (e.g., unintentional touch by the user or other personnel) and thus is not easily installed insecurely or damaged.

In the third aspect, the projection device is arranged spaced apart from the grip portion of the handle in the longitudinal direction of the handle to avoid touching the projection device when the user of the vehicle grips the handle, thereby not affecting the user experience and reducing the likelihood of damage to the projection device.

In the fourth aspect, the cooperation of the deployment of the handle and the movement of the projection device enables the projection device to project images of a wider variety of areas and shapes in a wider variety of projection regions to implement a wider variety of projection modes. Moreover, the corresponding deployment of the projection device along with the deployment of the handle relative to the vehicle door provides a dimension of movement of the projection device. The projection driving device driving the movement of the projection device provides another dimension of movement of the projection device. The present disclosure uses the dimension of movement of the original handle of the vehicle as a dimension of movement of the projection device, so that the number of dimensions of movement that the projection driving device needs to provide for the projection device can be reduced, and the structure of the projection driving device can be simplified, thus simplifying the structures of the vehicle and the door handle system thereof, and reducing the cost of improvement.

In the fifth aspect, the control of the degree of deployment of the handle and the movement position of the projection device based on the operating state of the vehicle enables the projection device to project desired images in a wider variety of projection modes, to achieve a wider variety of interactions of the vehicle with other vehicles, pedestrians, etc. and a wider variety of experiences for the user of the vehicle.

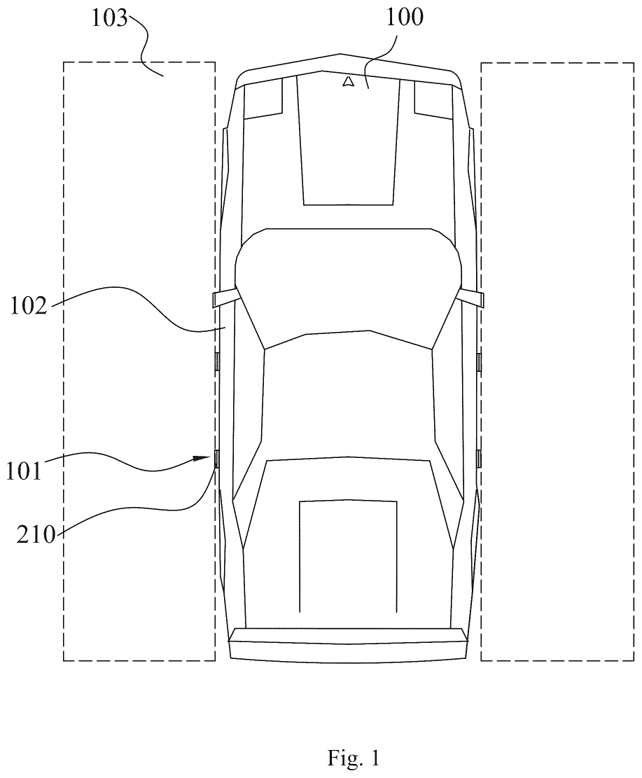

FIG. 1 shows a structural schematic view of a vehicle 100 and its components and projection regions of the present disclosure, to illustrate the positional relationship of the vehicle 100 and its components and projection regions.

As shown in FIG. 1, vehicle doors 102 on two sides of the vehicle 100 are each provided with a handle 101. The handle 101 is a flush handle which can be driven to move by a handle driving device (not shown), such as a motor, so as to be deployed or retracted relative to the vehicle door 102. When the handle 101 is driven by the handle driving device to deploy relative to the vehicle door 102, a user of the vehicle can grip the handle 101 to open the vehicle door 102. When the vehicle door 102 is opened, the user of the vehicle releases the handle 101, and then the handle 101 is driven by the handle driving device to retract relative to the vehicle door 102. When the handle 101 is retracted, an outer surface of the handle 101 is flush with an outer surface of the vehicle door 102.

A projection device 210 is arranged in the handle 101. The projection device 210 has an obscured position and one or more projection position. In the obscured position, the projection device 210 is obscured by the vehicle door 102. In the one or more projection position, the projection device 210 is partly obscured or not obscured by the vehicle door 102. The projection device 210 is configured to, as the handle 101 is deployed relative to the vehicle door 102, move from the obscured position to the one or more projection position, so that the projection device 210 projects an image to a projection surface. The projection device 210 is deployed or retracted relative to the vehicle door 102 accordingly as the handle 101 is deployed or retracted. The projection device 210 is mounted to face the projection surface, such as the ground near the vehicle or other suitable surfaces where an image is to be projected, so that the image can be projected on the projection surface. To clearly show the handle 101, each of the four handles 101 in FIG. 1 is extended from an opening on the vehicle door 102, that is, the handle 101 is in a deployed state. In this case, the projection device 210 on the handle 101 is also extended (i.e., deployed). For example, the projection device 210 is not obscured by the vehicle door 102 or is partially obscured by the vehicle door 102, so that the projection device 210 can project an image on the projection surface in a projection region 103, to provide corresponding instructions to the user, other vehicles, pedestrians, etc. A degree of deployment of the handle 101 relative to the vehicle door 102 is adjustable such that a part of the projection device 210 that is obscured by the vehicle door 102 has an adjustable size. When the handle 101 is deployed to a degree of deployment, the projection device 210 is partially obscured by the vehicle door 102. When the handle 101 is deployed to another degree of deployment, the projection device 210 is not obscured by the vehicle door 102. The size of the part of the projection device 210 that is obscured by the vehicle door 102 changes based on the degree of deployment of the handle 101.

The projection regions 103 are located on the ground near two sides of the vehicle 100 and extend over approximately the entire length of the body of the vehicle 100. The projection region 103 on the left side of the vehicle 100 is a combination of the projection regions of the projection devices 210 of the two handles 101 on the left side of the vehicle 100, and the projection region 103 on the right side of the vehicle 100 is a combination of the projection regions of the projection devices 210 of the two handles 101 on the right side of the vehicle 100. The images projected by the projection devices 210 in the two handles 101 on one side of the vehicle door 102 can be spliced in front and rear directions to form a longer projected image.

The projection device 210 can be driven by a projection driving device to move, such as rotate, relative to the handle 101. The movement of the projection device 210 can change the shape and/or area of the image projected by the projection device 210 on the projection surface, and/or the projection region 103 where the image is located. The position of the projection device 210 relative to the handle 101 after movement cooperates with the degree of deployment of the handle 101 relative to the vehicle door 102 such that the projection device 210 projects a wider variety of images, for example, having different shapes, areas and/or projection regions, on the projection surface, thereby satisfying a wider variety of desired projection modes, and achieving a wider variety of interactions of the vehicle 100 with other vehicles, pedestrians, etc. and a wider variety of experiences for the user of the vehicle.

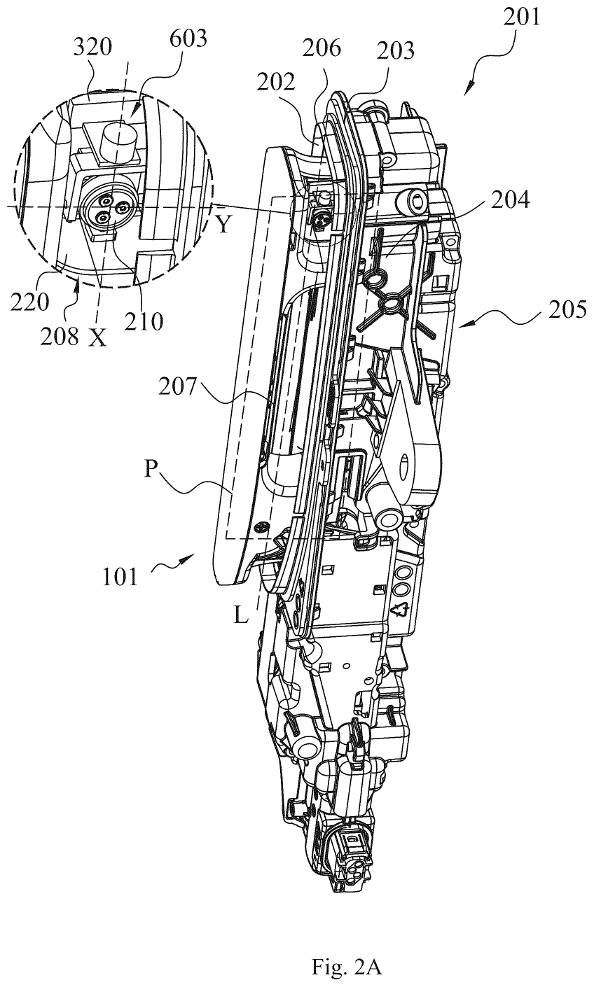

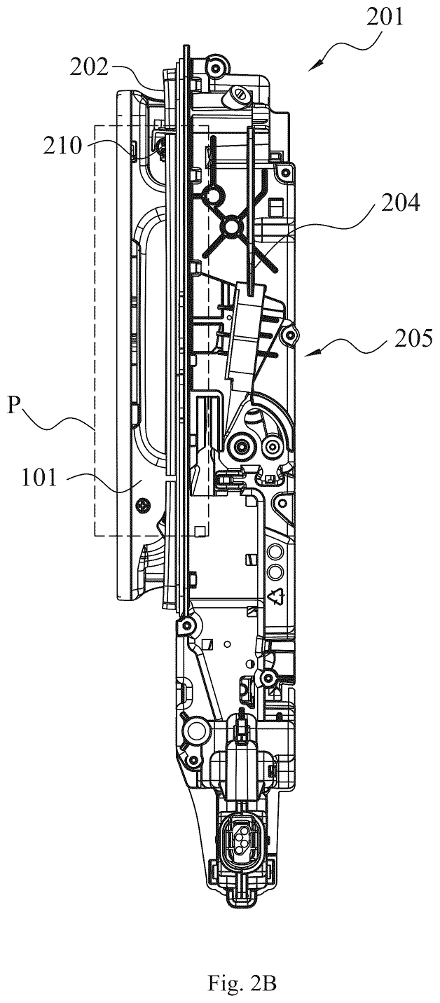

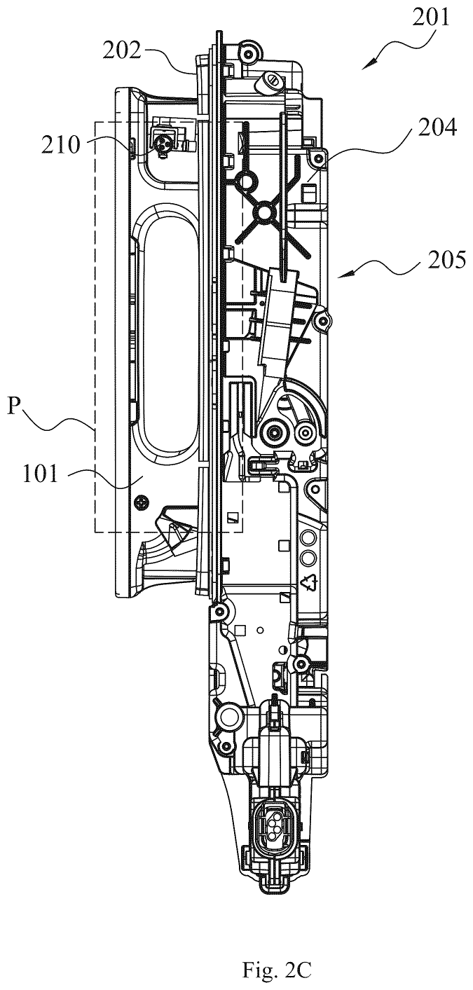

FIG. 2A is a structural schematic perspective view of the handle 101 shown in FIG. 1 mounted in a base 201 of the vehicle door, FIG. 2B is a front view of the handle 101 shown in FIG. 2A in a partially deployed state, FIG. 2C is a front view of the handle 101 shown in FIG. 2A in a fully deployed state, to illustrate the positional and mating relationships of the handle 101 with other components. A projection device 210 and a projection driving device 603 mounted in the handle 101 are shown in a partial enlarged view of FIG. 2A.

As shown in FIG. 2A, the handle 101 is mounted to the base 201 mounted in the vehicle door. The base 201 includes a housing 205. In an embodiment, the base 201 is mounted to the vehicle door by means of a flange 203 on the housing 205 of the base, so as to mount the handle 101 to the vehicle door. The handle 101 can be moved relative to the base 201 to be deployed or retracted, and thus deployed or retracted relative to the vehicle door. The housing 205 of the base 201 defines an opening 202. The handle 101 can be moved out of or into the opening 202 of the base 201 to be deployed or retracted relative to the base 201.

When the handle 101 is retracted relative to the base 201, the outer surface of the handle 101 is flush with the outer surface of the vehicle door to which the base 201 is mounted. In an embodiment, the plane where an outer edge 206 of the flange 203 of the base 201 facing the handle 101 is located is flush with the outer surface of the vehicle door. When the handle 101 is retracted relative to the base 201, the outer surface of the handle 101 is flush with the plane where the outer edge 206 of the base 201 is located, and thus flush with the outer surface of the vehicle door. The projection device 210 is mounted in the handle 101. When the handle 101 moves out of the opening 202 of the base 201, the projection device 210 can be moved out accordingly without being obscured by a side wall 204 of the housing 205 of the base 201 or partially obscured by the side wall 204, so that a corresponding image can be projected on the projection surface. The projection device 210 faces the side wall 204. When the projection device 210 is obscured by the side wall 204 of the base 201, the projection device 210 is obscured by the vehicle door accordingly.

The projection driving device 603 is mounted on the projection device 210. The projection driving device 603 drives the movement of the projection device 210 to change the shape and/or area of the image projected by the projection device 210 on the projection surface, and/or the projection region where the image is located. The projection driving device 603 shown in FIG. 2A drives the projection device 210 to rotate around a first axis of rotation Y and around a second axis of rotation X. The projection device 210 rotates around the first axis of rotation Y and the second axis of rotation X independently of each other. The first axis of rotation Y and the second axis of rotation X are different. The handle 101 is moved out of or into the opening 202 of the base 201 along a plane P to be deployed or retracted relative to the vehicle door. The first axis of rotation Y and the second axis of rotation X are parallel to the plane P. The first axis of rotation Y is perpendicular to the second axis of rotation X. In other embodiments, the projection driving device 603 includes other suitable driving devices or structures to drive the movement of projection device 210 to perform the above function.

The handle 101 includes a grip portion 207. When the handle 101 is deployed, the user of the vehicle can grip the grip portion 207 to open the vehicle door. The handle 101 is provided with a projection mounting portion 208. The projection mounting portion 208 is recessed inwardly from a surface of the handle 101 facing the bottom of the vehicle to receive the projection device 210 and the projection driving device 603. The projection device 210 and the projection driving device 603 are mounted in the projection mounting portion 208 such that when the handle 101 is deployed or retracted relative to the base 201, the projection device 210 and the projection driving device 603 are deployed or retracted relative to the base 201 accordingly, without contacting the base 201, thereby preventing damage or insecure mounting due to contact and preventing the movement of the handle 101 from being affected. The projection mounting portion 208 includes a projection mounting surface 220. The projection device 210 and the projection driving device 603 may be mounted to the projection mounting surface 220 via a bracket 320. The projection mounting surface 220 is a flat surface.

In a longitudinal direction L (length extension direction) of the handle 101 (in a substantially vertical direction shown in FIG. 2A), the projection mounting portion 208 is arranged spaced apart from the grip portion 207. The projection device 210 and the projection driving device 603 mounted in the projection mounting portion 208 are arranged spaced apart from the grip portion 207 accordingly, in order to prevent the user of the vehicle from touching the projection device 210 and the projection driving device 603 when griping the grip portion 207 of the handle 101, thereby not affecting the user experience and preventing the projection device 210 and the projection driving device 603 from being damaged or insecurely mounted due to touch, and improving the stability of the door handle system. The grip portion 207 is arranged in the middle portion of the handle 101, and the projection mounting portion 208 is arranged at an end portion of the handle 101.

FIGS. 2B-2C show that the handle 101 is translated along the plane P relative to the opening 202 of the base 201 to be deployed or retracted relative to the base 201 in an embodiment. As shown in FIG. 2B, the handle 101 is translated outwardly from the opening 202 by a first distance such that the handle 101 is in a partially deployed state relative to the base 201, in which case the projection device 210 is partially obscured by the side wall 204 of the housing 205 of the base 201. As shown in FIG. 2C, the handle 101 is translated outwardly from opening 202 by a second distance greater than the first distance such that the handle 101 is in a fully deployed state relative to the base 201, in which case the projection device 210 is not obscured by the side wall 204 of the base 201. When the handle 101 is not translated outwardly from the opening 202 (i.e., is retracted into the base 201) such that the handle 101 is in a retracted state relative to the base 201, the entire projection device 210 is thus obscured by the side wall 204 of the base 201.

In another embodiment, the handle 101 is pivoted around a pivotal axis along a plane P in an opening of an base to be deployed or retracted relative to the base. The handle 101, at an end away from the pivotal axis, is provided with a projection mounting portion for receiving and mounting the projection device 210 and the projection driving device 603. When the handle 101 is pivoted around the pivotal axis, the projection device 210 can be moved out or in accordingly without being obscured or being partially or fully obscured. In other embodiments, the handle 101 is deployed or retracted relative to the base by other suitable structures and/or manners.

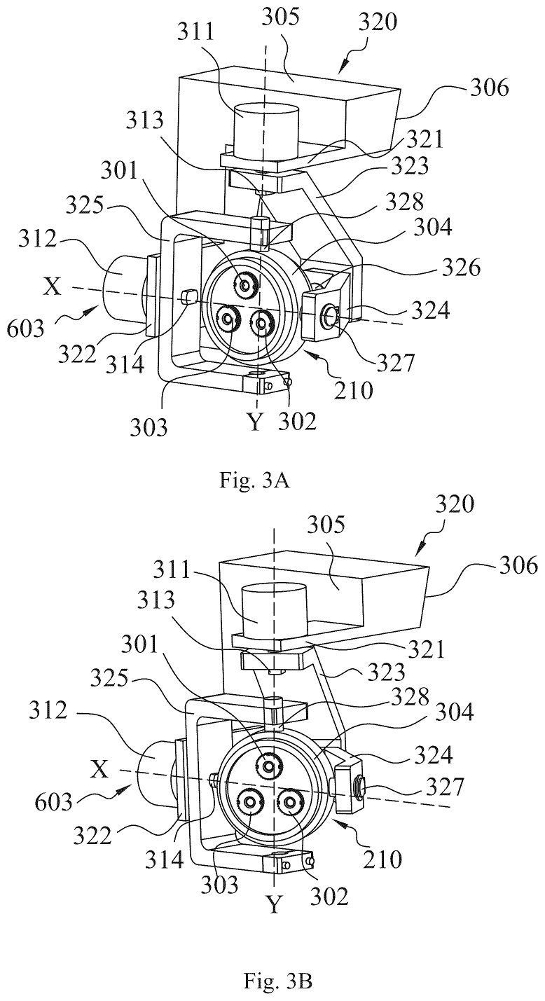

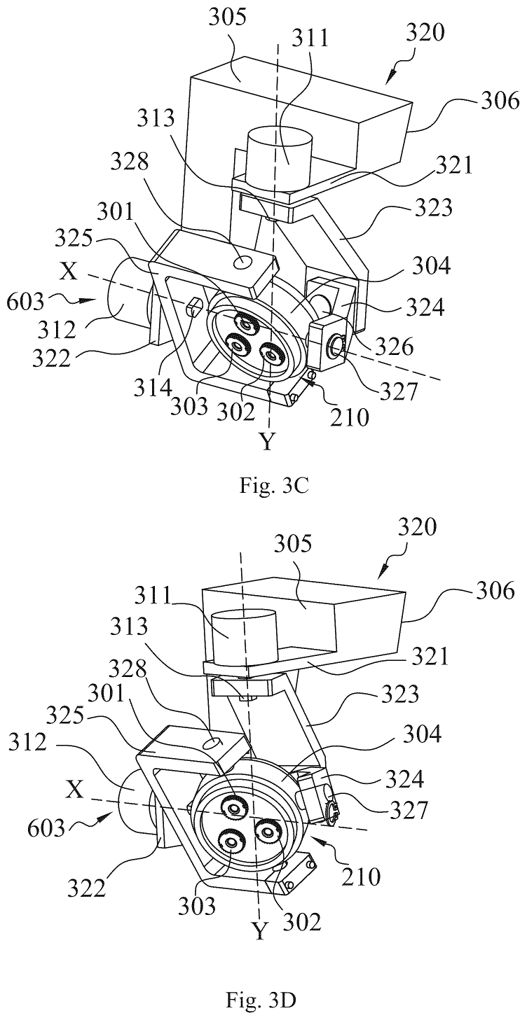

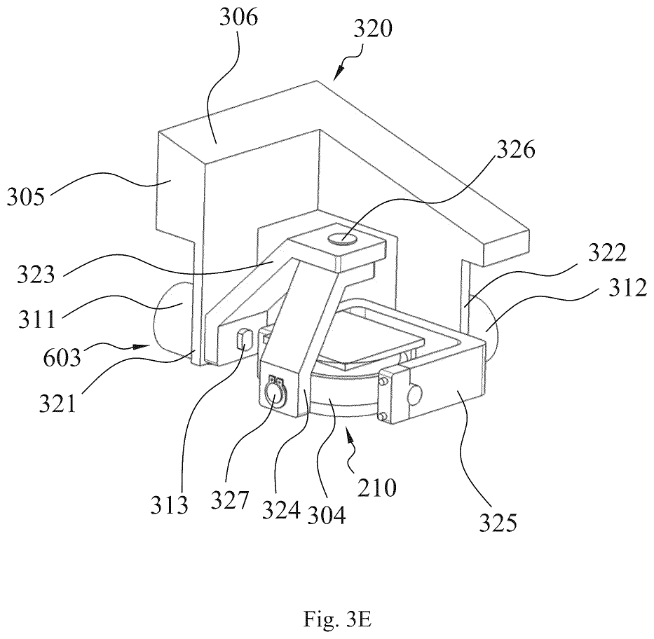

FIG. 3A is a structural schematic perspective view of the projection device 210 and the projection driving device 603 of the handle shown in FIG. 2A that are mounted together when viewed from a first angle, with the projection device 210 in an unrotated state, i.e., in an initial state. FIG. 3B is a structural schematic perspective view of the projection device 210 shown in FIG. 3A after being rotated by 30° around the first axis of rotation Y, FIG. 3C is a structural schematic perspective view of the projection device 210 shown in FIG. 3A after being rotated by 30° around the second axis of rotation X, and FIG. 3D is a structural schematic perspective view of the projection device 210 shown in FIG. 3A after being rotated by 30° around both the first axis of rotation Y and the second axis of rotation X. FIG. 3E is a structural schematic perspective view of the projection device 210 and the projection driving device 603 mounted together shown in FIG. 3A when viewed from a second angle.

As shown in FIGS. 3A-3E, the projection driving device 603 is connected to the projection device 210 to drive the rotation of the projection device 210. The projection driving device 603 and the projection device 210 are mounted to the handle of the vehicle door via a bracket 320. The bracket 320 includes a main body 305 including a side surface 306. The side surface 306 is arranged substantially parallel to a projected image output surface of the projection device 210 and away from the projection device 210. The projected image output surface is an outside surface of the projection device 210 that outputs a projected image to a projection surface. The bracket 320 is mounted to the handle via the side surface 306, to mount the projection driving device 603 and the projection device 210 to the handle. For example, the side surface 306 of the bracket 320 can be engaged with a projection mounting surface 220 (see FIG. 2A) on the projection mounting portion of the handle.

The projection device 210 includes a first projection head 301, a second projection head 302, a third projection head 303, and a mounting main body 304. The projection heads are all mounted in the mounting main body 304. The projection driving device 603 includes a first projection motor 311 and a second projection motor 312. The bracket 320 further includes a first arm 321 and a second arm 322 arranged opposite to the side surface 306. The main body 305 of the bracket 320 is substantially L-shaped. The first arm 321 extends from one end of the main body 305, for example in a horizontal direction. The second arm 322 extends from the other end of the main body 305, for example in a vertical direction. The first projection motor 311 is mounted to the first arm 321 of the bracket 320. The second projection motor 312 is mounted to the second arm 322 of the bracket 320. The first arm 321 and the second arm 322 are of a plate-like structure. In other embodiments, the first arm 321 and the second arm 322 include other suitable structures. In other embodiments, the bracket 320 includes other suitable structures. In an embodiment, the bracket 320 may be a part of the base 201.

The first projection motor 311 of the projection driving device 603 drives the projection device 210 to rotate around the first axis of rotation Y. The second projection motor 312 of the projection driving device 603 drives the projection device 210 to rotate around the second axis of rotation X. The first projection motor 311 is connected to the projection device 210 via a first connection member 323 and a second connection member 324, to drive the projection device 210 to rotate around the first axis of rotation. A first output shaft 313 of the first projection motor 311 extends from the first arm 321 of the bracket 320 to be connected to one end of the first connection member 323. The other end of the first connection member 323 is connected to one end of the second connection member 324, and the other end of the second connection member 324 is connected to the mounting main body 304 of the projection device 210. The first connection member 323 is fixedly connected to the second connection member 324 via a first coupling structure 326. The second connection member 324 is fixedly connected to the mounting main body 304 via a second coupling structure 327. The first projection motor 311 operates to rotate its first output shaft 313, and the rotation of the first output shaft 313 drives the first connection member 323 to rotate, thereby moving the second connection member 324 to rotate the mounting main body 304 around the first axis of rotation Y, so that the first projection head 301, the second projection head 302 and the third projection head 303 rotate around the first axis of rotation Y. As shown in FIGS. 3A-3D, the first axis of rotation Y is a vertical axis. In an embodiment, the first coupling structure 326 and the second coupling structure 327 are connecting rods. In other embodiments, the first coupling structure 326 and the second coupling structure 327 include other suitable coupling structures.

The second projection motor 312 is connected to the projection device 210 via a third connection member 325 to drive the projection device 210 to rotate around the second axis of rotation. A second output shaft 314 of the second projection motor 312 extends from the second arm 322 to be connected to the middle portion of the third connection member 325. One end of the third connection member 325 is connected to the mounting main body 304 of the projection device 210. The third connection member 325 is fixedly connected to the mounting main body 304 via a third coupling structure 328. The third connection member 325 is U-shaped. The second projection motor 312 operates to rotate its second output shaft 314, the rotation of the second output shaft 314 drives the third connection member 325 to rotate, thereby rotating the mounting main body 304 around the second axis of rotation X, so that the first projection head 301, the second projection head 302 and the third projection head 303 rotate around the second axis of rotation X. As shown in FIGS. 3A-3D, the second axis of rotation X is a horizontal axis. In an embodiment, the third coupling structure 328 is a connecting rod. In other embodiments, the third coupling structure 328 includes other suitable coupling structures. In other embodiments, the first projection motor 311 and the second projection motor 312 are connected to the projection device 210 by means of other suitable structures, so that the first projection motor 311 and the second projection motor 312 can drive the projection device 210 to rotate around the first axis of rotation Y and the second axis of rotation X independently of each other.

As shown in FIG. 3A, neither of the first projection motor 311 nor the second projection motor 312 operates so that the projection device 210 is in the unrotated state, i.e., in the initial state. As shown in FIG. 3B, the first projection motor 311 operates to drive the projection device 210 to rotate by 30° around the first axis of rotation Y, and the second projection motor 312 does not operate so that the projection device 210 does not rotate around the second axis of rotation X. As shown in FIG. 3C, the second projection motor 312 operates to drive the projection device 210 to rotate by 30° around the second axis of rotation X, and the first projection motor 311 does not operate so that the projection device 210 does not rotate around the first axis of rotation Y. As shown in FIG. 3D, the first projection motor 311 operates to drive the projection device 210 to rotate by 30° around the first axis of rotation Y, and the second projection motor 312 operates to drive the projection device 210 to rotate by 30° around the second axis of rotation X. In other embodiments, the projection device 210 may rotate around the first axis of rotation Y and/or the second axis of rotation X by other suitable angles into an appropriate position, to perform an appropriate projection operation.

In an embodiment, the projection head of the projection device 210 includes a light source and an optical structure. The light from the light source passes through the optical structure and presents an image on the projection surface. When a pattern piece is inserted in the optical structure, the pattern can be presented on the projection surface. For example, the optical structure includes a condensing lens and an imaging lens. The pattern piece is located between the condensing lens and the imaging lens. This structure makes the projection device 210 have a relatively small structure so as to be suitable for being mounted on the handle and have a lower cost. The projection device of the present disclosure includes other suitable projection heads and may perform projection display in other suitable ways.

In an embodiment, one of the first projection head 301, the second projection head 302 and the third projection head 303 performs projection to implement a first projection mode, another one performs projection to implement a second projection mode, and the remaining one performs projection to implement a third projection mode. In an embodiment, in the first projection mode, a desired pattern piece is provided in the projection head to project a desired pattern. The first projection mode includes a welcome mode. As the user of the vehicle approaches the vehicle with a vehicle key, the handle may be progressively deployed relative to the vehicle door so that the projection head is progressively deployed relative to the vehicle door, thereby progressively presenting a projected pattern on the projection surface (e.g., on the ground near the vehicle). The projected pattern changes from less to more as the degree of deployment of the handle changes from small to large. The pattern is presented in a dynamic manner, thereby enhancing the experience of the user of the vehicle. If it needs to project other patterns, the pattern piece or the projection head may be changed.

In the second projection mode, no pattern piece is provided, but different colors of light are emitted by the light source to make the projection head project images of different colors in the projection region. The light source includes a multiple-color LED. By controlling a chip equipped in the light source, the multiple-color LED emits light of the desired colors for the desired duration, so that the projection head can project the image of the desired colors in the desired mode. For example, a yellow image is projected in a width indication mode of the vehicle so that other vehicles can determine the size and width of the vehicle, thereby improving driving safety. A green image is projected in a charging mode of the vehicle to indicate to the user of the vehicle and other persons that the vehicle is charging. A blue image is projected in an advanced driver assistance system mode of the vehicle to indicate to other persons or vehicles that the user of the vehicle has activated an advanced driver assistance system function of the vehicle to enable other persons to drive their vehicles safely. In a lane change mode of the vehicle, a breathing yellow image is projected on the side of the vehicle, on which the vehicle is about to change lanes, to indicate to other persons or vehicles that the vehicle is about to change lanes. For example, in the present disclosure, a projection device 210 (including a projection head) on a vehicle door on a corresponding side of the vehicle is controlled to project a desired image based on a turn signal of the vehicle (e.g., a left turn signal or a right turn signal).

In the third projection mode, an image of a desired area and/or shape is projected in a desired projection region by cooperating the degree of deployment of the handle with the rotational position of the projection device 210. Moreover, the images projected by the projection devices 210 (for example, using one of the projection heads) on the front and rear vehicle doors on one side of the vehicle are spliced in the front and rear directions to project the desired image. The third projection mode includes a turning mode for indicating a dangerous region when the vehicle is turning to alert pedestrians, other vehicles (e.g., bicycles), etc.

In other embodiments, the present disclosure may implement other suitable projection modes. The present disclosure can implement the above projection modes with other suitable number of projection heads. For example, the projection device 210 may include only one projection head or include two projection heads to implement at least one of the first, second, and third projection modes described above. The present disclosure may project an image on a projection surface on two sides or one side of the vehicle as required. The present disclosure may implement the above projection modes of the vehicle using other suitable colors or presentation modes (e.g., a flashing mode).

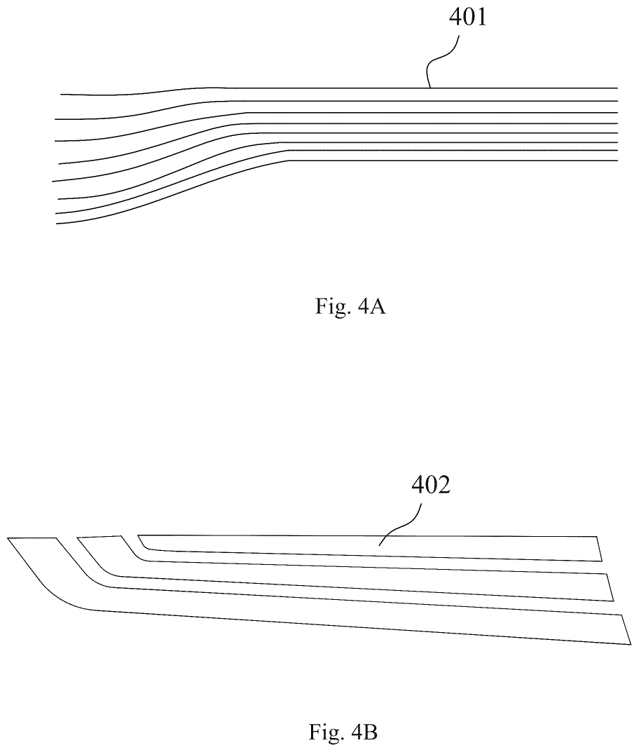

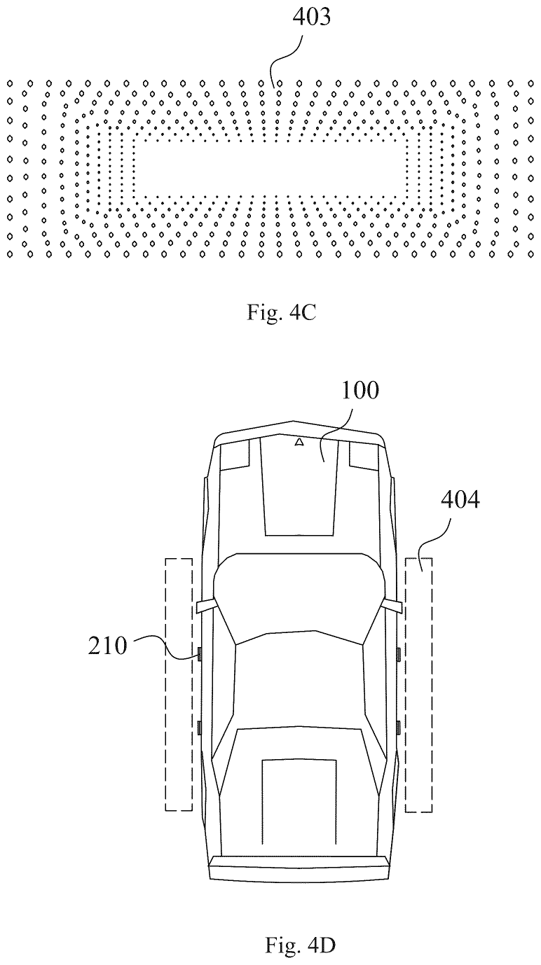

FIGS. 4A-4C show schematic views of images in the first projection mode of the present disclosure, and FIG. 4D shows a schematic view of a projection region in which an image is projected in the second projection mode of the present disclosure. As shown in FIG. 4A, the image in the first projection mode includes a first pattern image 401. As shown in FIG. 4B, the image in the first projection mode includes a second pattern image 402. As shown in FIG. 4C, the image in the first projection mode includes a third pattern image 403. In other embodiments, the image in the first projection mode of the present disclosure includes other suitable pattern images.

As shown in FIG. 4D, the projected image in the second projection mode is located in a projection region 404. In the second projection mode, one projection head, such as one projection head of the projection device on the handle 101 of the front vehicle door, is used to project an image in the projection region 404. FIG. 4D shows the projection region 404 in the form of an elongated block. In other embodiments, the present disclosure includes a projection region of other suitable shapes.

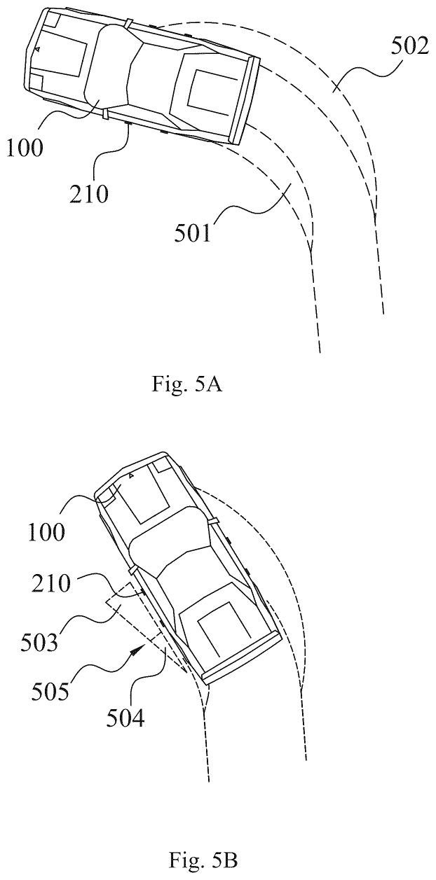

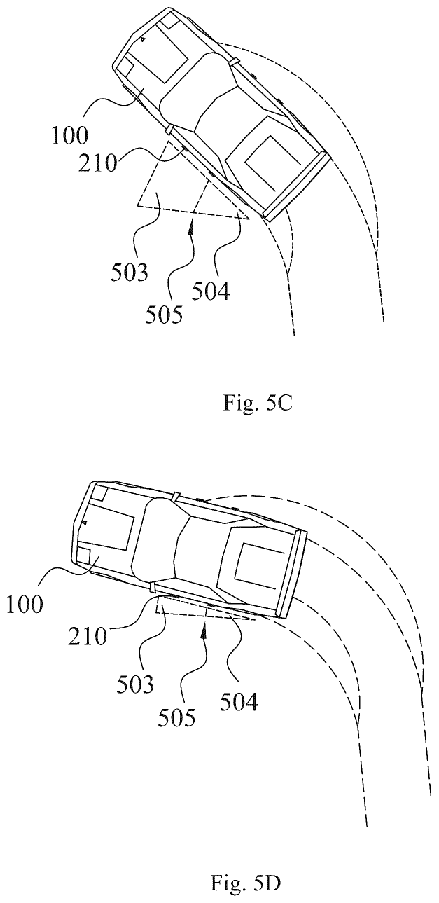

FIG. 5A shows a schematic view of run-over regions of inner and outer wheels of the vehicle 100 during a turn, FIG. 5B is a schematic view of an image projected by the projection device 210 at the beginning of the turn of the vehicle 100 shown in FIG. 5A, FIG. 5C is a schematic view of an image projected by the projection device 210 half-way through the turn of the vehicle 100 shown in FIG. 5A, FIG. 5D is a schematic view of an image projected by the projection device 210 near the completion of the turn of the vehicle 100 shown in FIG. 5A, to show that the vehicle 100 presents the desired projected images in the turning mode.

The projection device 210 of the present disclosure can project a desired image when the vehicle 100 is turning, to indicate a dangerous region when the vehicle is turning. The projected image can change accordingly as the angle of the turn of the vehicle 100 changes. As shown in FIG. 5A, when the vehicle 100 turns from the right to the left, the inner wheels of the vehicle (the left wheels of the vehicle) travel in an inner wheel run-over region 501, and the outer wheels of the vehicle (the right wheels of the vehicle) travel in an outer wheel run-over region 502.

As shown in FIG. 5B, when the vehicle 100 starts turning, the projection devices 210 of the left vehicle doors on the front and rear sides both perform projection to present an image in a combined projection region 505, i.e., a large triangular region. For example, red appears in the combined projection region 505. The combined projection region 505 includes a front projection region 503 projected by the projection device 210 of the left vehicle door on the front side and a rear projection region 504 projected by the projection device 210 of the left vehicle door on the rear side. The front projection region 503 is substantially trapezoidal and the rear projection region 504 is substantially triangular. The front projection region 503 and the rear projection region 504 are spliced into a combined projection region 505. In an embodiment, the handles on the left vehicle doors may be deployed to a desired degree of deployment such that the projection devices 210 mounted thereto are obscured by the vehicle doors, and the front and rear projection devices 210 each rotate to a desired position to present an image in the combined projection region 505.

As shown in FIG. 5C, when the vehicle 100 is half-way through the turn, the projection devices 210 of the left vehicle doors on the front and rear sides project to present an image in the combined projection region 505. The combined projection region 505 includes a front projection region 503 projected by the projection device 210 of the left vehicle door on the front side and a rear projection region 504 projected by the projection device 210 of the left vehicle door on the rear side. The combined projection region 505 in FIG. 5C has a larger area than the combined projection region 505 in FIG. 5B. In an embodiment, the handles in the embodiment shown in FIG. 5C are deployed to a greater degree of deployment (including full deployment) than in FIG. 5B such that fewer portions of the projection devices 210 mounted thereto are obscured (including not obscured), and the front and rear projection devices 210 each rotate to a desired position to present an image in the combined projection region 505 having a larger area.

As shown in FIG. 5D, as the vehicle 100 approaches the completion of the turn, the projection devices 210 of the left vehicle doors on the front and rear sides project to present an image in the combined projection region 505. Compared to the combined projection regions 505 in FIGS. 5B-5C, the combined projection region 505 in FIG. 5D has the smallest area. At the completion of the turn of the vehicle 100, the combined projection region 505 is substantially in the form of a straight line. In an embodiment, the handles in the embodiment shown in FIG. 5D are deployed to a smaller degree of deployment than in FIGS. 5B-5C such that more portions of the projection devices 210 mounted thereto are obscured, and the front and rear projection devices 210 each rotate to a desired position to present an image in the combined projection region 505 having the smallest area. In an embodiment, the images presented in the projection regions 505 in FIGS. 5B-5D have no pattern but only appear in red.

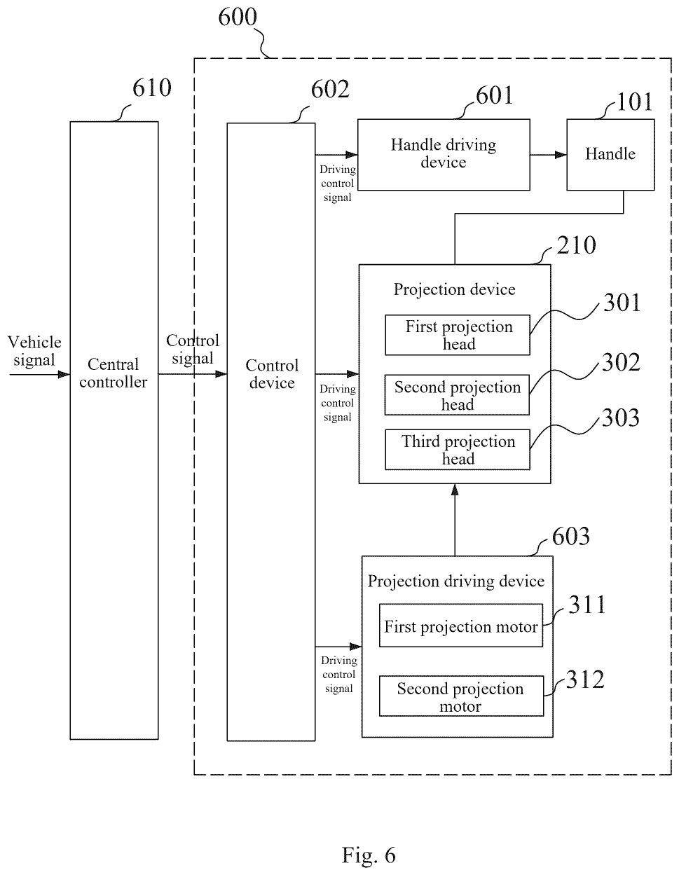

FIG. 6 is a block diagram of the structure of a door handle system 600 of the vehicle shown in FIG. 1. The door handle system 600 is connected to a central controller 610 of the vehicle. As shown in FIG. 6, the door handle system 600 includes a handle 101, a handle driving device 601, a projection device 210, a projection driving device 603, and a control device 602. The control device 602 is connected to the handle driving device 601, the projection device 210 and the projection driving device 603, and is configured to control the operations of these devices.

In an embodiment, the central controller 610 generates control signals for the door handle system 600 based on a vehicle signal of the vehicle received, to control operation of the door handle system 600 such that the door handle system 600 implements projection in various projection modes. The vehicle signal of the vehicle is used to indicate the operating state of the vehicle, including, for example, a vehicle key approach signal, a vehicle door closed signal, a driver sitting signal, a width indication signal, a charging signal, an advanced driver assistance system function activation signal (Adas signal), a turn signal, a vehicle speed signal, a turn angle signal, etc. The control signals for the door handle system 600 include a handle deployment/retraction control signal, a projection movement control signal, a projection operation control signal, etc. The handle deployment/retraction control signal is used to indicate a degree of deployment or retraction of the handle 101, the projection movement control signal is used to indicate a movement of the projection device 210 relative to the handle 101, and the projection operation control signal is used to indicate the selection of a projection head of the projection device 210 and the operation manner of the selected projection head. The control device 602 of the door handle system 600 receives control signals from the central controller 610 to generate a driving control signal for the handle driving device 601, a driving control signal for the projection driving device 603, and a driving control signal for the projection device 210, to control the operations of the handle driving device 601, the projection driving device 603 and the projection device 210 to project corresponding images in various projection modes. In other embodiments, the control device 602 implements the above control based on other suitable signals.

The control device 602 is configured to generate a driving control signal for the handle driving device 601 to control the operation of the handle driving device 601 such that the handle driving device 601 drives the movement of the handle 101 to deploy or retract relative to the vehicle door. The deployment of the handle 101 includes that the handle 101 is deployed to a degree of deployment. The projection device 210 and the projection driving device 603 are mounted to the handle 101 so that they move accordingly when the handle 101 moves.

The control device 602 is further configured to generate a driving control signal for the projection driving device 603 to control the operation of the projection driving device 603 such that the projection driving device 603 controls the movement of the projection device 210. The projection driving device 603 includes a first projection motor 311 and a second projection motor 312. The control device 602 is configured to generate a driving control signal for the first projection motor 311 to control the operation of the first projection motor 311 to drive the projection device 210 to rotate around a first axis of rotation by a required angle, and to generate a driving control signal for the second projection motor 312 to control the operation of the second projection motor 312 to drive the projection device 210 to rotate around a second axis of rotation by a required angle. The control device 602 independently controls the operations of the first projection motor 311 and the second projection motor 312.

Moreover, the control device 602 is further configured to generate a driving control signal for the projection device 210 to control the operation of the projection device 210 to project a desired image. The projection device 210 includes a first projection head 301, a second projection head 302, and a third projection head 303. The control device 602 is configured to generate a driving control signal for the projection device 210 to control the activation of a light source of a corresponding projection head of the projection device 210, for example, one of the first projection head 301, the second projection head 302 and the third projection head 303, and control the operation of a chip which cooperates with the light source of the corresponding projection head to control the color of light emitted by the light source and the duration of the light emitted to project the image, thereby implementing a variety of projection modes. In an embodiment, a projection device 210 is mounted to the handle 101 of each vehicle door of the vehicle. In other embodiments, a projection device 210 is mounted to a suitable handle 101 of the vehicle. The control device 602 is configured to generate a driving control signal for the projection device 210 to selectively control the operation of at least one projection device 210 of the vehicle and to selectively control the operation of at least one projection head of the projection device 210 to project an image for a desired projection mode.

In an embodiment, when each projection mode of the vehicle is activated, each component of the door handle system 600 starts to operate from its initial position. Upon completion of each projection mode of the vehicle, each component of the door handle system 600 is reset to its initial position. For example, in the door handle system 600, the handle driving device 601 is reset to its initial position to move the handle 101 to the initial position, that is, the handle 101 is retracted relative to the vehicle door; and the projection driving device 603 is reset to its initial position to move the projection device 210 to the initial position relative to the handle 101, and the projection head of the projection device 210 is reset to its initial position, for example, the light source of the projection head is deactivated and the chip that cooperates with the light source is returned to its initial state.

In an embodiment, in the welcome mode of the vehicle, when the user of the vehicle approaches the vehicle with a vehicle key, the central controller 610, based on a vehicle key approach signal, generates a handle deployment control signal to instruct the handle 101 to be fully deployed, and generates a projection operation control signal to instruct a predetermined projection head of the projection device 210 to be selected to operate to project the image. The control device 602 generates a driving control signal for the handle driving device 601 based on the handle deployment control signal from the central controller 610, to control the operation of the handle driving device 601 to drive the handle 101 to gradually deploy from the initial position (retracted position) to the fully deployed position. The control device 602 further generates a driving control signal for the projection device 210 based on the projection operation control signal from the central controller 610, to control the activation of the light source of a corresponding projection head, for example the first projection head 301, of the projection device 210, to project a desired image, for example, to project a pattern image. When the vehicle door is closed and the user of the vehicle is seated on a driver's seat of the vehicle, the central controller 610 generates a reset control signal for the door handle system 600 based on a vehicle door closed signal and a driver sitting signal to control the components of the door handle system 600 to be reset to their initial positions.

In an embodiment, in the width indication mode of the vehicle, when the user of the vehicle presses a width indication key, the central controller 610, based on a width indication signal, generates a handle deployment control signal to instruct the handle 101 to be fully deployed, and generates a projection operation control signal to instruct a predetermined projection head of the projection device 210 to be selected and the projection head to project an image of a predetermined color. The control device 602 generates a driving control signal for the handle driving device 601 based on the handle deployment control signal from the central controller 610, to control the operation of the handle driving device 601 to drive the handle 101 to deploy from the initial position (retracted position) to the fully deployed position. The control device 602 further generates a driving control signal for the projection device 210 based on the projection operation control signal from the central controller 610 to control the activation of the light source of a corresponding projection head, for example the second projection head 302, of the projection device 210, and the operation of the chip that cooperates with the light source to project an image of a corresponding color, for example, yellow. When the user of the vehicle restores the width indication key, the central controller 610 generates a reset control signal for the door handle system 600 based on a width indication cancel signal to control the components of the door handle system 600 to be reset to their initial positions.

In an embodiment, the projection operations of the vehicle in the charging mode and the advanced driver assistance system mode are similar to the projection operation in the width indication mode described above. The difference is that in the charging mode of the vehicle, the central controller 610 generates a handle deployment control signal and a projection operation control signal for instructing a predetermined projection head of the projection device 210 to project a green image, based on a charging signal. The central controller 610 generates a reset control signal for the door handle system 600 based on a charging completion signal. In the advanced driver assistance system mode of the vehicle, the central controller 610 generates a handle deployment control signal and a projection operation control signal for instructing a predetermined projection head of the projection device 210 to project a blue image, based on an advanced driver assistance system function activation signal (Adas signal). The central controller 610 generates a reset control signal for the door handle system 600 based on an advanced driver assistance system operation cancel signal.

In an embodiment, in the lane change mode of the vehicle, when the user of the vehicle presses a turning key, the central controller 610, based on a turn signal, generates a handle deployment control signal to instruct the handles 101 on one side of the vehicle (the side on which the vehicle is about to change lanes) to be fully deployed, and generates a projection operation control signal to instruct a predetermined projection head of the projection device 210 on the side of the vehicle to be selected and the projection head to project an image of a predetermined color in a predetermined manner. The control device 602 generates a driving control signal for the handle driving device 601 based on the handle deployment control signal from the central controller 610, to control the operation of the handle driving device 601 on one side of the vehicle to drive the corresponding handle 101 to deploy from the initial position (retracted position) to the fully deployed position. The control device 602 further generates a driving control signal for the projection device 210 based on the projection operation control signal from the central controller 610, to control the activation of the light source of a corresponding projection head, for example the second projection head 302, of the projection device 210 on one side of the vehicle and the operation of the chip that cooperates with the light source to project an image of a corresponding color in a corresponding manner. For example, a pulsating yellow image is projected. When the user of the vehicle restores the turning key, the central controller 610 generates a reset control signal for the door handle system 600 based on a turning cancel signal to control the components of the door handle system 600 to be reset to their initial positions.

In an embodiment, in the turning mode of the vehicle, when the user of the vehicle turns a steering wheel and applies a brake, the central controller 610, based on a turn angle signal and a vehicle speed signal of the vehicle, generates a handle deployment control signal to instruct a degree of deployment of the handle 101 on one side of the vehicle (the side toward which the turning is made), generates a projection movement control signal to instruct an angle of rotation of each of the first projection motor 311 and the second projection motor 312 of the projection driving device 603 on the side of the vehicle, and generates a projection operation control signal to instruct a predetermined projection head of the projection device 210 on the side of the vehicle to be selected and the projection head to project an image of a predetermined color. The control device 602 generates a driving control signal for the handle driving device 601 based on the handle deployment control signal from the central controller 610 to control the operation of the handle driving device 601 on one side of the vehicle to drive the corresponding handle 101 to deploy from the initial position (retracted position) to the corresponding degree of deployment. The control device 602 generates driving control signals for the first projection motor 311 and the second projection motor 312 based on a projection movement control signal from the central controller 610, to control the operations of the first projection motor 311 and the second projection motor 312 on one side of the vehicle, to drive the corresponding projection device 210 to rotate around the first axis of rotation by a corresponding first angle of rotation and around the second axis of rotation by a corresponding second angle of rotation. The control device 602 further generates a driving control signal for the projection device 210 based on the projection operation control signal from the central controller 610 to control the activation of the light source of a corresponding projection head, for example the third projection head 303, of the projection device 210 on one side of the vehicle, and the operation of the chip that cooperates with the light source to project an image of a corresponding color, for example, red. When the user of the vehicle restores the turning key, the central controller 610 generates a reset control signal for the door handle system 600 based on a turning cancel signal to control the components of the door handle system 600 to be reset to their initial positions. The degree of deployment of the handle 101 relative to the vehicle door cooperates with the first angle of rotation of the projection device 210 around the first axis of rotation and the second angle of rotation around the second axis of rotation such that the projection device 210 projects an image of a desired shape and area in a desired projection region to indicate a dangerous region when the vehicle is turning.

In other embodiments, the present disclosure implements the projection in each aforementioned projection mode and the resetting upon completion of each projection mode in other suitable manners. In an embodiment, the handle driving device 601 and the control device 602 are components of an actuator. The handle driving device 601 is a motor of the actuator. The control device 602 is a controller of the actuator. In other embodiments, the door handle system 600 includes other suitable structures.

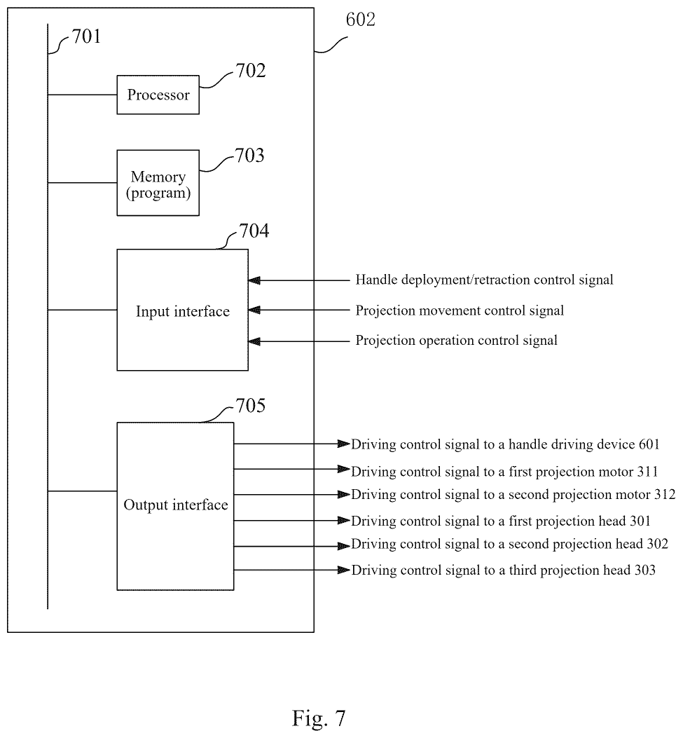

FIG. 7 is a block diagram of the structure of the control device 602 of the door handle system shown in FIG. 6. As shown in FIG. 7, the control device 602 includes a bus 701, a processor 702, a memory 703, an input interface 704 and an output interface 705. The processor 702, the memory 703, the input interface 704 and the output interface 705 are connected to the bus 701. The processor 702 can read a program (or an instruction) from the memory 703 and execute the program (or the instruction) to perform processing on data. The processor 702 can further write data or the program (or the instruction) into the memory 703. The memory 703 can store the program (or the instruction) or the data. By executing the instruction in the memory 703, the processor 702 can control the memory 703, the input interface 704 and the output interface 705.

The input interface 704 is configured to receive control signals, such as a handle deployment/retraction control signal, a projection movement control signal, a projection operation control signal, etc. from the central controller of the vehicle. The input interface 704 is further configured to convert the received signals (or data) into signals (or data) recognizable by the processor 702 and output the signals (or data) to the processor 702. The processor 702 is configured to process (e.g., calculate) the received signals (or data) to generate a driving control signal for the handle driving device 601, driving control signals for the first projection motor 311 and the second projection motor 312 of the projection driving device, and driving control signals for the first projection head 301, the second projection head 302 and the third projection head 303 of the projection device.

The output interface 705 is configured to receive the driving control signals from the processor 702, convert the driving control signals respectively into signals suitable for the components, such as the handle driving device 601, the first projection motor 311 and the second projection motor 312 of the projection driving device, and the first projection head 301, the second projection head 302 and the third projection head 303 of the projection device, and send the signals respectively to the components to control the operations of the components, thereby implementing the control of the vehicle in the various projection modes.

Although the present disclosure is described in conjunction with the examples of embodiments outlined above, various alternatives, modifications, variations, improvements, and/or substantial equivalents that are known or current or to be anticipated before long may be obvious to those of at least ordinary skill in the art. In addition, the technical effects and/or technical problems described in this specification are exemplary rather than limiting. Therefore, the disclosure in this specification may be used to solve other technical problems and have other technical effects and/or may solve other technical problems. Accordingly, the examples of the embodiments of the present disclosure as set forth above are intended to be illustrative rather than limiting. Various changes can be made without departing from the spirit or scope of the present disclosure. Therefore, the present disclosure is intended to include all known or earlier developed alternatives, modifications, variations, improvements and/or basic equivalents.

Description of main reference signs

| | | | |
|---|---|---|---|
| Vehicle | 100 | Handle | 101 |
| Vehicle door | 102 | Projection region | 103, |
| | | | 404 |
| Base | 201 | Opening | 202 |
| Flange | 203 | Side wall | 204 |
| Housing | 205 | Outer edge | 206 |
| Grip portion | 207 | Projection mounting portion | 208 |
| Projection device | 210 | Fixed end | 211 |
| Free end | 212 | Projection mounting surface | 220 |
| First projection head | 301 | Second projection head | 302 |
| Third projection head | 303 | Mounting main body | 304 |
| Main body | 305 | Side surface | 306 |
| First projection motor | 311 | Second projection motor | 312 |
| First output shaft | 313 | Second output shaft | 314 |
| Bracket | 320 | First arm | 321 |
| Second arm | 322 | First connection member | 323 |
| Second connection | 324 | Third connection member | 325 |
| member | | | |
| First coupling structure | 326 | Second coupling structure | 327 |
| Third coupling structure | 328 | First pattern image | 401 |
| Second pattern image | 402 | Third pattern image | 403 |
| Inner wheel run-over | 501 | Outer wheel run-over | 502 |
| region | | region | |
| Front projection region | 503 | Rear projection region | 504 |
| Combined projection region | 505 | Door handle system | 600 |
| Handle driving device | 601 | Control device | 602 |
| Projection driving device | 603 | Central controller | 610 |
| Bus | 701 | Processor | 702 |
| Memory | 703 | Input interface | 704 |
| Output interface | 705 | | |

What is claimed is:

1. A door handle system for a vehicle door, the door handle system comprising:
a handle;
a handle driving device configured to drive the handle to deploy or retract relative to the vehicle door; and
a projection device arranged in the handle and having an obscured position and one or more projection position, the projection device being configured to, as the handle is deployed relative to the vehicle door, move from the obscured position to the one or more projection position so that the projection device projects an image to a projection surface.

2. The door handle system according to claim 1, wherein the door handle system further comprises:
a projection driving device connected to the projection device and configured to drive the projection device to move relative to the handle.

3. The door handle system according to claim 2, wherein the projection device moves relative to the handle to project an image of a predetermined shape and area on a predetermined projection region of the projection surface.

4. The door handle system according to claim 2, wherein the projection driving device drives the projection device to rotate relative to the handle, wherein the projection device rotates around a first axis of rotation and a second axis of rotation independently of each other.

5. The door handle system according to claim 4, wherein the handle is deployed or retracted along a plane relative to the vehicle door, the first axis of rotation and the second axis of rotation are parallel to the plane, and the first axis of rotation is perpendicular to the second axis of rotation.

6. The door handle system according to claim 2, wherein the projection device and the projection driving device are arranged spaced apart from a grip portion of the handle in a longitudinal direction of the handle.

7. The door handle system according to claim 4, wherein the projection driving device comprises a first projection motor and a second projection motor,
wherein the first projection motor is configured to drive the projection device to rotate around the first axis of rotation, the second projection motor is configured to drive the projection device to rotate around the second axis of rotation.

8. The door handle system according to claim 7, wherein the projection driving device is mounted to the handle via a bracket,
wherein the bracket comprises a main body comprising a side surface which is mounted to the handle,
the main body further comprises a first arm and a second arm arranged opposite to the side surface, the first projection motor is mounted to the first arm, and the second projection motor is mounted to the second arm.

9. The door handle system according to claim 8, wherein a first output shaft of the first projection motor is connected to the projection device via a first connection member and a second connection member, the first output shaft rotates to drive the first connection member and the second connection member to rotate so as to drive the projection device to rotate around the first axis of rotation,
a second output shaft of the second projection motor is connected to the projection device via a third connection member, the second output shaft rotates to drive the third connection member to rotate so as to drive the projection device to rotate around the second axis of rotation.

10. The door handle system according to claim 2, wherein the door handle system further comprises:
a control device configured to:
control operation of the handle driving device to deploy or retract the handle,
control operation of the projection driving device to move the projection device, and
control operation of the projection device to project the image.

11. The door handle system according to claim 10, wherein the control of a degree of deployment of the handle relative to the vehicle door, a manner of operation of the projection driving device and movement of the projection device relative to the handle is determined based on an operating state of a vehicle.

12. The door handle system according to claim 10, wherein the projection device comprises a first projection head, and in a first projection mode, during controlling the handle driving device to drive the handle to deploy, the control device controls the first projection head of the corresponding projection device mounted to the handle to actuate to project an image with a pattern, so that the projected image is gradually presented as the handle is gradually deployed.

13. The door handle system according to claim 10, wherein the projection device comprises a second projection head, and in a second projection mode, the control device controls the handle driving device to drive the handle to deploy and controls the second projection head of the corresponding projection device mounted to the handle to actuate and project an image of a predetermined color for a predetermined duration.

14. The door handle system according to claim 10, wherein the projection device comprises a third projection head, and in a third projection mode, as for each handle on two vehicle doors on one side of a vehicle and the corresponding first projection motor, second projection motor and projection device mounted to each handle, the control device controls the handle driving device to drive each handle to deploy to a predetermined degree of deployment, controls the operation of the corresponding first projection motor to drive the corresponding projection device to rotate around the first axis of rotation by a first angle of rotation, controls the operation of the corresponding second projection motor to drive the corresponding projection device to rotate around the second axis of rotation by a second angle of rotation, and controls the third projection head of the corresponding projection device to actuate and project an image of a predetermined color, wherein the images projected by the corresponding third projection head on each handle are spliced to form a combined image.

15. The door handle system according to claim 14, wherein the third projection mode is a turning mode, the control of the degree of deployment of the handle relative to the vehicle door, the first angle of rotation of the projection device around the first axis of rotation and the second angle of rotation around the second axis of rotation are determined based on a turn angle signal and a vehicle speed signal of the vehicle.

16. The door handle system according to claim 10, wherein the control device is a single controller.

17. A vehicle comprising a door handle system of claim 1.
